(19) United States
(12) Patent Application Publication
(10) Pub. No.: US 2010/0185966 A1
(43) Pub. Date: Jul. 22, 2010

(54) Smart Control Panels

(75) Inventors: Daniel Jette, Orleans (CA); Steven Mark Szoczei, Ottawa (CA); Matthew Robert Schnarr, Ottawa (CA); Aliaksandr Piashko, Kanata (CA)

Correspondence Address: HENSLEY KIM & HOLZER, LLC, 1660 LINCOLN STREET, SUITE 3000, DENVER, CO, 80264, US

(73) Assignee: COREL CORPORATION, OTTAWA, ON (CA)

(21) Appl. No.: 12/568,008

(22) Filed: Sep. 28, 2009

Related U.S. Application Data
(60) Provisional application No. 61/145,489, filed on Jan. 16, 2009.

(51) Int. Cl. G06F 3/048

(52) U.S. Cl. 715/768; 715/856

(57) ABSTRACT

The presently disclosed technology teaches graphical user interfaces (GUIs) grouped in smart control panels that fade, disappear, move, rotate, and/or resize to reveal a work surface under the smart control panels. In one implementation, a smart control panel disappears until it is recalled by a keystroke. When the smart control panel is recalled, it reappears at a present location of a cursor on the work surface. In another implementation, the smart control panel disappears when the user renders an image in an area occupied by the smart control panel. More specifically, a cursor renders a mark across the work surface. As the mark reaches the smart control panel, the smart control panel disappears while the mark is rendered in the area occupied by the smart control panel. When the mark is no longer being rendered in the area occupied by the smart control panel, the smart control panel reappears.

### CROSS REFERENCE

This application claims the benefit of U.S. Provisional Application No. 61/145,489, filed Jan. 16, 2009, entitled “Smart Control Panels,” the content of which is hereby incorporated by reference in its entirety.

### BACKGROUND

Many computer systems have graphical user interfaces (GUIs) through which an operating system and application software functionality is accessed. The GUIs can represent computer application programs, documents, and data files as graphically displayed GUI objects, such as icons and menus. The GUI objects can be manipulated by a user to control and activate system and application functions. The user may manipulate the GUI objects by using an input device such as a mouse, keyboard, touch screen, etc. Microsoft Windows® and Apple Macintosh MacOS® operating systems are examples of common GUI-based computer operating systems that support GUI-based applications.

A well-designed GUI interface can facilitate the user's understanding and use of a software application. Some GUI objects, such as icons, can include a picture or other characteristic that is intended to suggest a function associated with the GUI object. Such function-suggesting GUI objects can assist the user in learning and operating a software application. For example, to remind the user how to access paintbrush functionality, a drawing application can use an icon bearing a picture of a paintbrush.

Groupings of GUIs with similar functions are often used in menus and/or control panels with an overall function. For example, a drawing tools menu may include a paintbrush tool, a pencil tool, and a crayon tool. In some software applications, the user may create control panels with custom groupings of GUIs. The groupings of GUIs may be customized by GUI content and/or orientation within the custom control panel. Further, control panels containing groupings of GUIs may be positioned on a user display by the user in a location that is desirable to the user.

### SUMMARY

The presently disclosed technology provides graphical user interfaces (GUIs) grouped in smart control panels that fade, disappear, move, rotate, and/or resize to reveal a work surface or a portion thereof under the smart control panels.

In one implementation, in a default mode, each smart control panel stays visible and pinned in a selected position on a work surface unless a user manually repositions the smart control panel. When a temporal mode is activated, the smart control panel becomes unpinned and disappears until it is recalled by a keystroke or menu selection. When the smart control panel is recalled, it reappears at a present location of a cursor on the work surface. After the user is finished utilizing the smart control panel and the cursor is moved off of the smart control panel, the smart control panel disappears until it is recalled again by the keystroke or menu selection.

In another implementation, the smart control panel disappears when the user manipulates an image portion in an area occupied by the smart control panel. For example, a user input causes application software to renders a mark across the work surface. As the mark reaches, or comes in close proximity to the smart control panel, the smart control panel disappears while the mark is rendered in the area occupied by the smart control panel. When the mark is no longer being rendered in the area occupied by the smart control panel, the smart control panel reappears.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various implementations and implementations as further illustrated in the accompanying drawings and defined in the appended claims.

### BRIEF DESCRIPTIONS OF THE DRAWINGS

The presently disclosed technology is best understood from the following Detailed Description describing various implementations read in connection with the accompanying drawings.

FIG. 1 illustrates a computer monitor displaying example application software that includes four example smart control panels.

FIG. 2 illustrates an example color smart control panel oriented as a circular palette containing a grouping of GUIs.

FIG. 3 illustrates an example tools smart control panel oriented as a circular palette containing a grouping of GUIs.

FIG. 4 illustrates an example media smart control panel oriented as a circular palette containing a grouping of GUIs.

FIG. 5 illustrates an example media settings smart control panel oriented as a circular palette containing a grouping of GUIs.

FIG. 6 illustrates an example virtual canvas with four faded smart control panels.

FIG. 7 illustrates an example virtual canvas with an intensified color smart control panel.

FIG. 8 illustrates an example virtual canvas with a moveable tools smart control panel.

FIG. 9 illustrates an example virtual canvas with a resizable media smart control panel.

FIG. 10A illustrates an example virtual canvas with a smart control panel.

FIG. 10B illustrates the example virtual canvas of FIG. 10A with the smart control panel disappearing.

FIG. 10C illustrates the example virtual canvas of FIG. 10A with the smart control panel reappearing.

FIG. 11 illustrates an example virtual canvas with a smart control panel partially obscured by an edge of a display.

FIG. 12 illustrates example operations for selectively activating a smart control panel.

FIG. 13 illustrates example operations for inputting data on a work surface shown underneath a smart control panel.

FIG. 14 illustrates an example computing system that can be used to implement the presently disclosed technology.

### DETAILED DESCRIPTIONS

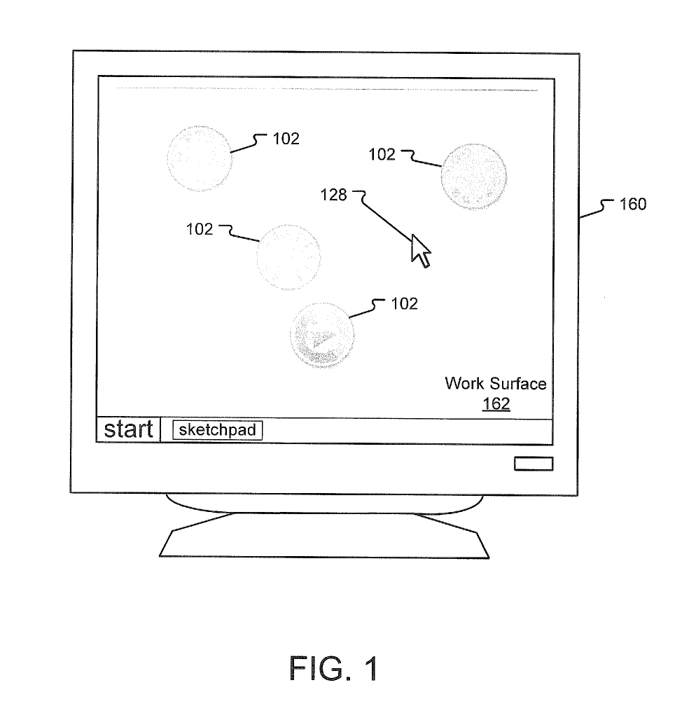

FIG. 1 illustrates a computer monitor 160 displaying four example smart control panels 102. The smart control panels 102 are rendered on a work surface 162 of the computer monitor 160 along with a cursor 128 that is used to manipulate the smart control panels 102. In one implementation, the work surface 162, each of the smart control panels 102, and the cursor 128 are each rendered on separate layers within a software application controlling the rendering on the computer monitor 160. The layers logically operate similarly to layers of objects in the physical world. For example, a first layer “on top of” a second layer partially or completely obscures the second layer. Similarly, a third layer “underneath” a fourth layer is partially or completely obscured by the fourth layer. The work surface 162, each of the smart control panels 102, and the cursor 128 are each assigned a layer within the software application that governs which layers are rendered on top of other layers. In many software applications, the cursor 128 is a “top” layer”, the smart control panels 102 are “middle” layers, and the work surface 162 is a “bottom” layer.

The smart control panels 102 are groupings of graphical user interfaces (GUIs) that fade, disappear, move, rotate, and/or resize to reveal the work surface 162 (e.g. a virtual canvas, notepad, control screen) under the smart control panels 102. The smart control panels 102 allow a user of the work surface 162 less distraction and interference with the work surface 162 while maintaining good accessibility to the smart control panels 102. Further, the user may view the entire work surface 162 or a selectable portion of the work surface 162 on a display (e.g. a computer display or screen).

While the smart control panels 102 are discussed with particularity with reference to drawing applications herein, the presently disclosed technology is equally applicable to other types of software applications (e.g. word processing, spreadsheet, database, presentation, internet, and CAD applications). Further, even though some of the various implementations described below reference specific types of smart control panels 102, all of the implementations apply equally to any other types and/or arrangements of the smart control panels 102.

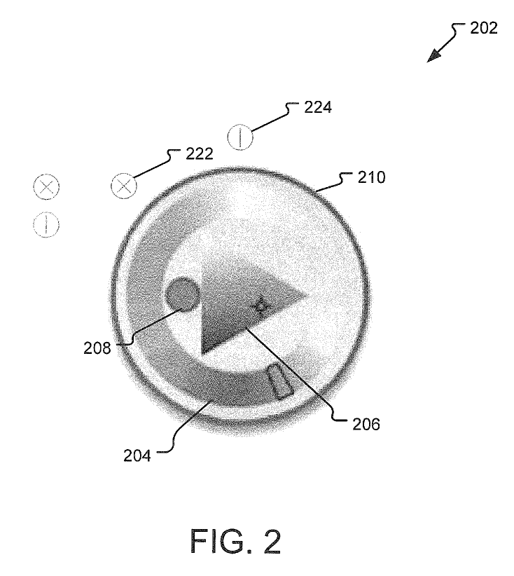

FIG. 2 illustrates an example color smart control panel 202 containing a grouping of GUIs. The smart control panel 202 includes a color palette 210 for use in a drawing application. The color palette 210 has a hue ring GUI 204 for selecting a desired hue for marking, a saturation triangle GUI 206 for selecting a desired saturation for marking, and a current color window GUI 208 for viewing a current selection of hue and saturation. The specific orientation and look of the GUIs 204, 206, 208 within the color palette 210 is an example only, other orientations are contemplated herein.

The smart control panel 202 also includes a hide GUI 222 located in an upper-left area of the smart control panel 202 outside of the circular palette 210. A user may elect to hide the smart control panel 202 by selecting the hide GUI 222. The smart control panel 202 then disappears from view to maximize access to a work surface. The user may show the hidden smart control panel 202 by a keyboard or menu selection to again gain quick access to the GUIs within the smart control panel 202.

The smart control panel 202 also includes a temporal mode GUI 224 in an upper-center area of the smart control panel 202 outside of the circular palette 210. In a default mode, the smart control panel 202 stays visible and pinned in a selected position on a display unless the user manually repositions the smart control panel 202. The default mode is indicated by a “|” in the temporal mode GUI 224.

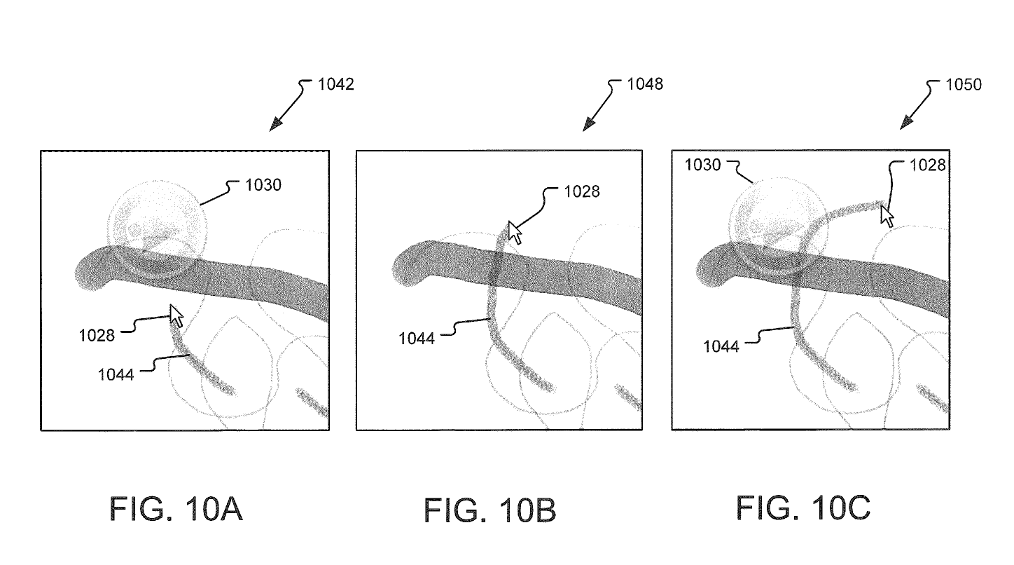

When temporal mode is activated by selecting the temporal mode GUI 224, the smart control panel 202 becomes unpinned and disappears until it is recalled by a keystroke or menu selection. When the smart control panel 202 is recalled, it reappears at a present location of a cursor on the display. After the user is finished utilizing the smart control panel 202 and the cursor is moved off of the smart control panel 202, the smart control panel 202 disappears until it is recalled again by the keystroke or menu selection. Temporal mode is indicated by an “O” in the temporal mode GUI 224. The user may return the smart control panel 202 to the default mode by selecting the temporal mode GUI 224 again. Temporal mode is described further with regard to FIGS. 10A-10C.

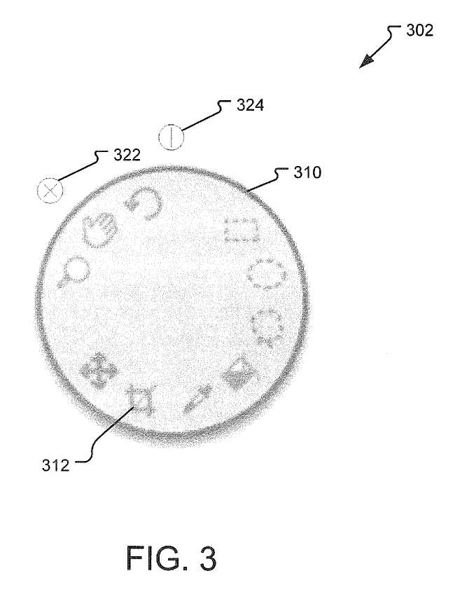

FIG. 3 illustrates an example tools smart control panel 302 containing a grouping of GUIs. The smart control panel 302 includes a tools palette 310 for use in the drawing application. The tools palette 310 has a number of tools GUIs 312 arranged around an inner perimeter of the tools palette 310. The tools GUIs 312 are configured to assist a user in viewing and adjusting a work surface, selecting work surface areas, and working with colors on the work surface. Example tools GUIs 312 within the tools palette 310 include work surface tools, selection tools, color tools, and adjustment tools. The specific orientation and look of the tools GUIs 312 within the tools palette 310 is an example only, other orientations are contemplated herein.

The smart control panel 302 also includes a hide GUI 322 located in an upper-left area of the smart control panel 302 outside of the circular palette 310. Similar to the hide GUI 222 of FIG. 2, a user may elect to hide the smart control panel 302 by selecting the hide GUI 322. Further, the smart control panel 302 also includes a temporal mode GUI 324 in an upper-center area of the smart control panel 302 outside of the circular palette 310. Similar to the temporal mode GUI 224 of FIG. 2, a user may select either a default mode or a temporal mode for the smart control panel 302 by selecting the temporal mode GUI 324.

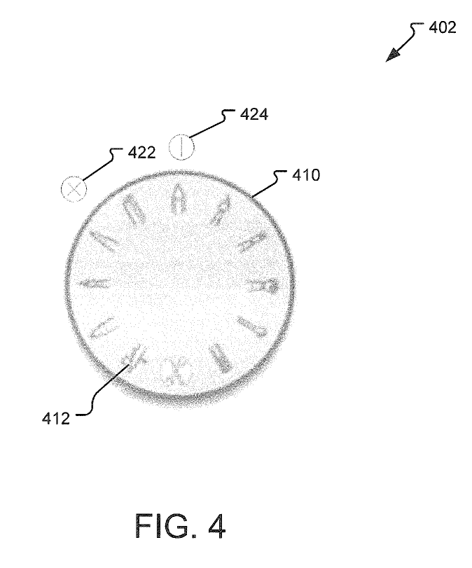

FIG. 4 illustrates an example media smart control panel 402 containing a grouping of GUIs. The smart control panel 402 includes a circular media palette 410 for use in the drawing application. The media palette 410 has a number of media GUIs 412 arranged around an inner perimeter of the media palette 410. The media GUIs 412 are configured to allow a user to select a desired media tool for rendering on the work surface. Example media GUIs 412 within the media palette 410 include pencil, chalk, pen, inking pen, marker, airbrush, watercolor, acrylic, and oil. Further, the user can blend different colors using a blender GUI and erase image areas using an eraser GUI. The specific orientation and look of the media GUIs 412 within the media palette 410 is an example only, other orientations are contemplated herein.

The smart control panel 402 also includes a hide GUI 422 located in an upper-left area of the smart control panel 402 outside of the circular palette 410. Similar to the hide GUI 222 of FIG. 2, a user may elect to hide the smart control panel 402 by selecting the hide GUI 422. Further, the smart control panel 402 also includes a temporal mode GUI 424 in an upper-center area of the smart control panel 402 outside of the circular palette 410. Similar to the temporal mode GUI 224 of FIG. 2, a user may select either a default mode or a temporal mode for the smart control panel 402 by selecting the temporal mode GUI 424.

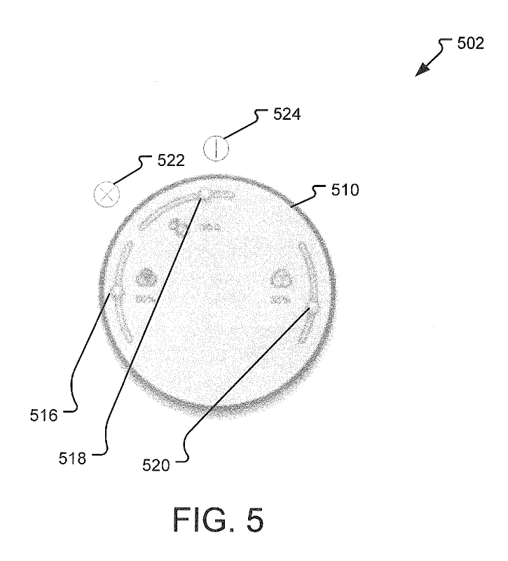

FIG. 5 illustrates an example media settings smart control panel 502 containing a grouping of GUIs. The smart control panel 502 includes a media settings palette 510 for use in the drawing application. The media settings palette 510 has an opacity slider GUI 516, a size slider GUI 518, and a grain slider GUI 520. The sliders 516, 518, and 520 allow a user to adjust the opacity, size, and grain of a selected media GUI 312 in the media palette 310 (see FIG. 3). The specific orientation and look of the media settings GUIs within the media settings palette 510 is an example only, other orientations are contemplated herein.

The smart control panel 502 also includes a hide GUI 522 located in an upper-left area of the smart control panel 502 outside of the circular palette 510. Similar to the hide GUI 222 of FIG. 2, a user may elect to hide the smart control panel 502 by selecting the hide GUI 522. Further, the smart control panel 502 also includes a temporal mode GUI 524 in an upper-center area of the smart control panel 502 outside of the circular palette 510. Similar to the temporal mode GUI 224 of FIG. 2, a user may select either a default mode or a temporal mode for the smart control panel 402 by selecting the temporal mode GUI 424.

In one implementation, each individual smart control panel 202, 302, 402, 502 of FIGS. 2-5 may be shown or hidden separately. In another implementation, two or more of the smart control panels 202, 302, 402, 502 are shown or hidden as a group.

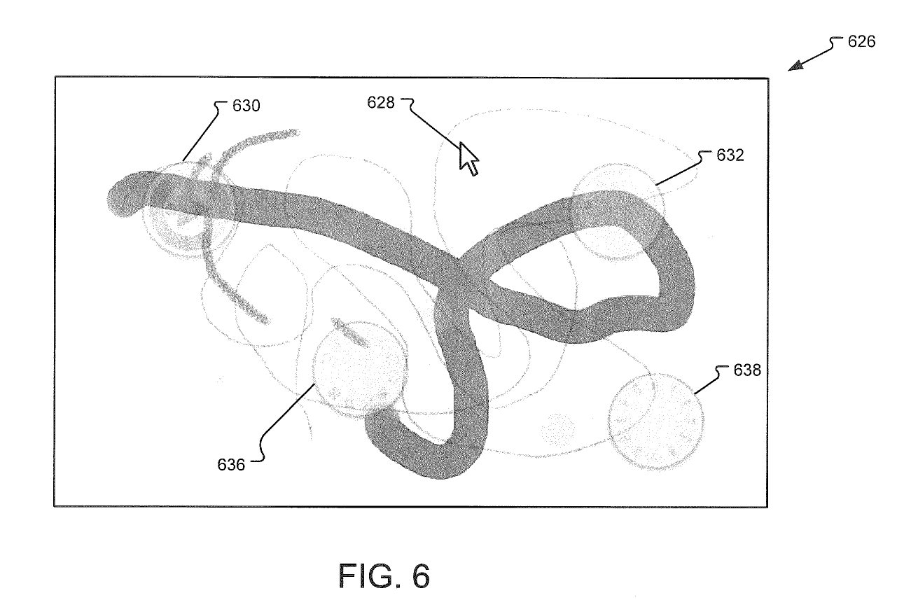

FIGS. 6-9 illustrate example virtual canvases 626, 726, 826, and 926 with smart control panels that fade, move, and are resizable. More specifically, FIG. 6 illustrates the example virtual canvas 626 with four faded smart control panels and various renderings. The four smart control panels are semi-transparent and include a color smart control panel 630, a tools smart control panel 636, a media smart control panel 638, and a media settings smart control panel 632.

A cursor 628 is shown oriented on the virtual canvas 626 but not over any of the smart control panels. Generally, when an inactive cursor (e.g., corresponding to un-clicked mouse) is oriented over a smart control panel, the drawing application assumes that the user wishes to access the smart control panel and the smart control panel intensifies or at least remains visible to the user. Similarly, if an inactive cursor becomes active while oriented on top of a smart control panel (e.g., when the user clicks the smart control panel with the mouse), the drawing application also assumes that the user wishes to access the smart control panel and the smart control panel intensifies or at least remains visible to the user. However, when an already active cursor (e.g., corresponding to a clicked-and-dragged mouse) is re-oriented over one of the smart control panels, the drawing application assumes that the user wishes to access the virtual canvas 626 underneath the active cursor and the smart control panel disappears or at least de-intensifies.

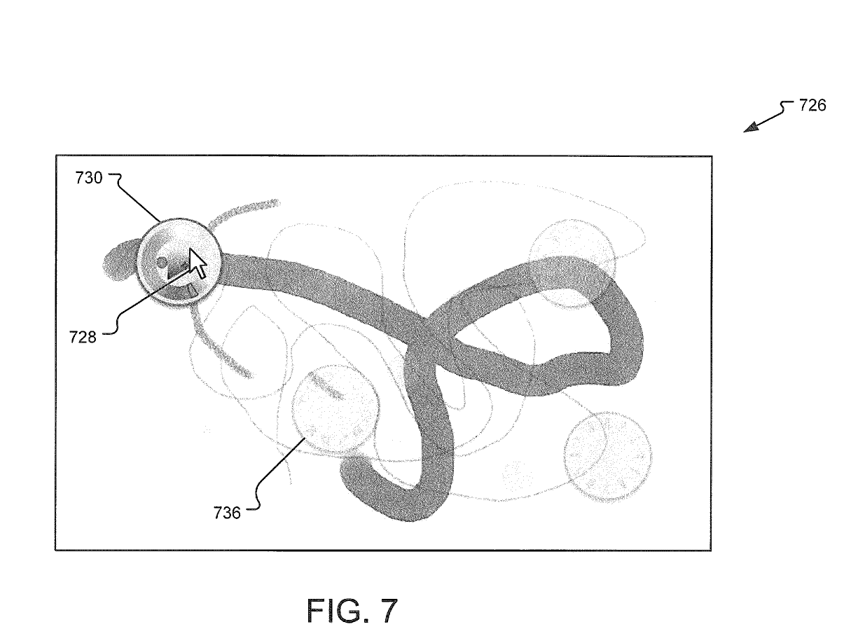

FIG. 7 illustrates an example virtual canvas 726 with an intensified color smart control panel 730. As a user orients a cursor 728 over the color smart control panel 730, the color smart control panel 730 becomes opaque or less transparent than on virtual canvas 626 in FIG. 6. In some implementations, positioning the cursor 728 over a smart control panel causes the smart control panel to become colored or change color. When the user orients the cursor 728 off of the color smart control panel 730, the color smart control panel 730 returns to a semi-transparent state as shown in FIG. 6.

If a hide GUI associated with the color smart control panel 730 is selected, then the color smart control panel 730 will disappear rather than merely return to a semi-transparent state when the user orients the cursor 728 off of the color smart control panel 730. In order for the user to recall the color smart control panel 730, the user may enter a keyboard or menu selection.

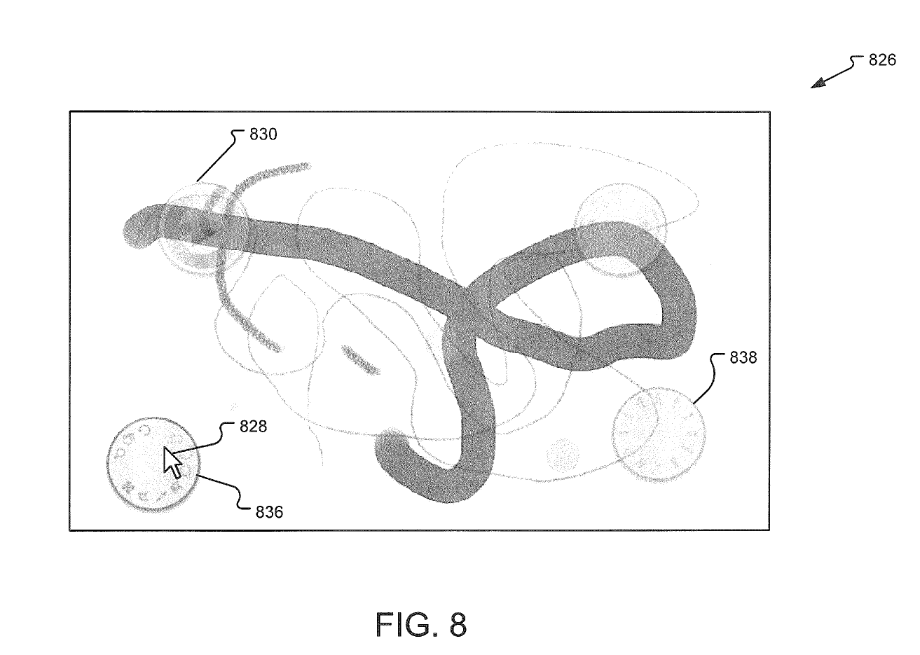

The user may also move smart control panels as desired. FIG. 8 illustrates an example virtual canvas 826 with a moveable tools smart control panel 836. The user can position the cursor 828 over a blank area of the tools smart control panel 836 and click-and-drag the tools smart control panel 836 to a different location on the virtual canvas 826. In FIG. 7, the tools smart control panel 636 is shown near a center of the virtual canvas 626. The user re-positions the tools smart control panel 636 by clicking-and-dragging it, resulting in the orientation of tools smart control panel 836 in the lower left of virtual canvas 826 in FIG. 8.

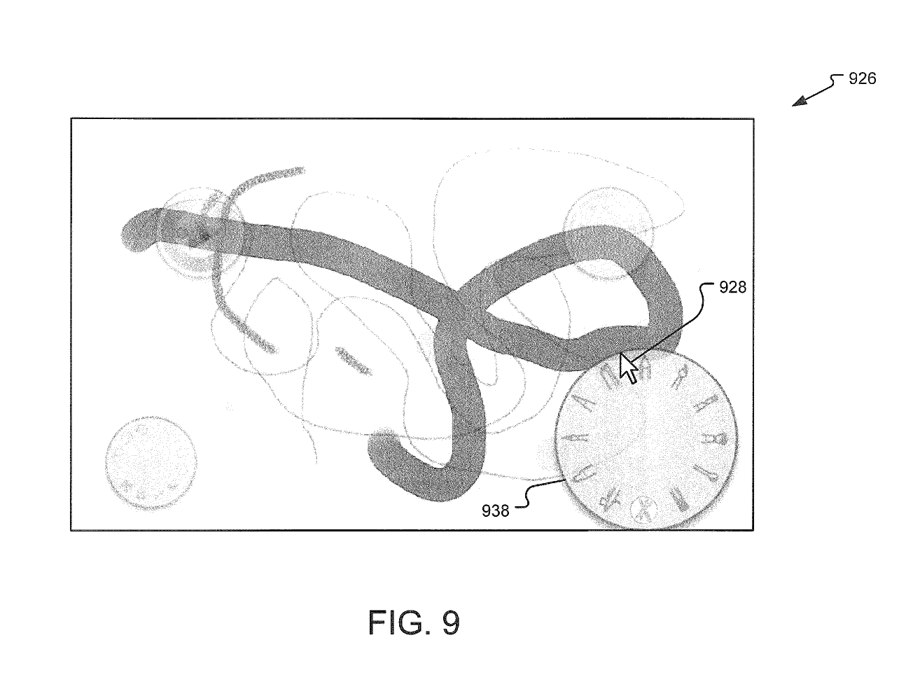

Still further, the user may also resize the smart control panels as desired. FIG. 9 illustrates an example virtual canvas 926 with a resizable media smart control panel 938. The user can position the cursor 928 over an outer edge of the media smart control panel 938 and click-and-drag the media smart control panel 938 to a different size on the virtual canvas 926. In FIG. 8, the media smart control panel 838 is shown at a first size. The user re-sizes the media palette 938 by clicking-and-dragging an outer edge of the media palette 938 outward as shown in FIG. 9.

FIGS. 10A-10C illustrate three example virtual canvases 1042, 1048, and 1050 with a color smart control panel 1030 that disappears when a user manipulates an image portion in an area occupied by the color smart control panel 1030. Virtual canvas 1042 in FIG. 10A has various renderings, a semi-transparent color smart control panel 1030, and a cursor 1028 oriented on the virtual canvas 1042 but not over the color smart control panel 1030. The cursor 1028 is rendering a mark 1044 across the virtual canvas 1042 corresponding to a user input (e.g., when a mouse is clicked-and-dragged across a surface). In another implementation, the user input is data input in the form of text on the virtual canvas 1042 or other virtual worksheet.

The mark 1044 is rendered across the virtual canvas 1042 in a direction of the color smart control panel 1030. Referring now to FIG. 10B, when the cursor 1028 reaches, or comes in close proximity to the color smart control panel 1030, the color smart control panel 1030 disappears while the mark 1044 is rendered in the area occupied by the color smart control panel 1030. In some implementations, a proximity of the cursor 1028 to the color smart control panel 1030 required to make the color smart control panel 1030 disappear is configurable by a user.

Referring now to FIG. 10C, when the mark 1044 is no longer being rendered in the area occupied by the color smart control panel 1030, such as when the cursor 1028 emerges from the area occupied by the color smart control panel 1030, the color smart control panel 1030 reappears. In another implementation, the color smart control panel 1030 will reappear if the cursor 1028 is un-clicked and the manipulation of the image portion stops when the cursor 1028 is still in the area occupied by the color smart control panel 1030 (e.g., when the mouse is un-clicked).

In another implementation, the color palette 1030 moves to a second location on the virtual canvas 1048 while the mark 1044 is being rendered in a first location previously occupied by the color smart control panel 1030. Further, the color smart control panel 1030 may return to the first location when the mark 1044 is no longer being rendered in the first location. In another implementation, the color palette 1030 does not return to the first location when the mark 1044 is no longer being rendered in the first location.

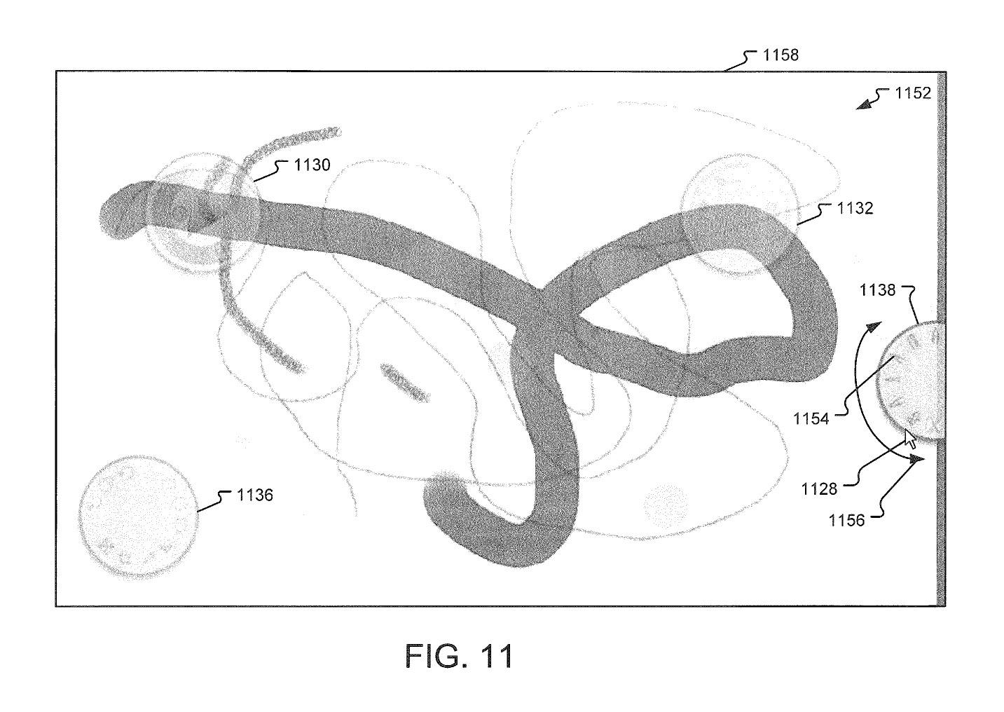

FIG. 11 illustrates an example virtual canvas 1152 with a media smart control panel 1128 partially obscured by an edge of a display 1158 of a virtual canvas 1152. The virtual canvas 1152 has various renderings and four faded smart control panels, a color smart control panel 1130, a tools smart control panel 1136, a media smart control panel 1138, and a media settings smart control panel 1132. The media smart control panel 1128 is oriented such that only half of the media smart control panel 1138 is visible on the display 1158 of the virtual canvas 1152. A cursor 1128 is shown oriented on an outer edge of the media palette 1138.

A user may desire to utilize the media smart control panel 1138 with the least amount of the media smart control panel 1138 occupying space in the display 1158. To that end, the user may elect to orient the media smart control panel 1138 where it is partially obscured by an edge of the display 1158. However, even when the media smart control panel 1138 is partially obscured, the user may still desire access to all GUIs 1154 on the media smart control panel 1138. According to the presently disclosed technology, the user may gain access to all of the GUIs 1154 on the media smart control panel 1138 by rotating the media smart control panel 1138.

More specifically, the user may gain access to the GUIs 1154 on obscured half of the media smart control panel 1138 by clicking-and-dragging an edge of the media smart control panel 1138 in one of directions 1156. Desired GUIs 1154 will then rotate into view on the display 1158 for the user to access. Other methods of rotating the smart control panel 1138 are contemplated herein.

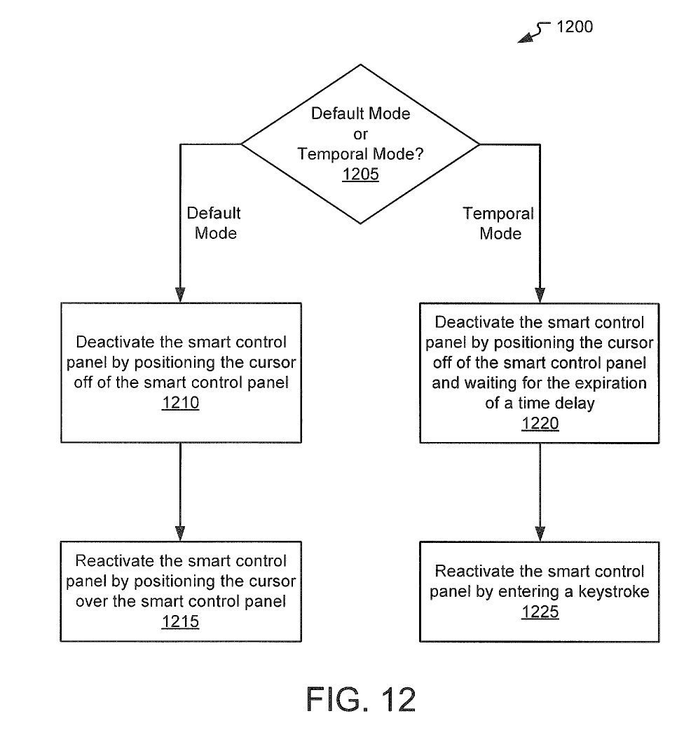

FIG. 12 illustrates example operations 1200 for selectively activating a smart control panel. In a mode selection operation 1205, a user selects either a default mode or a temporal mode on smart control panel using a cursor. If the user selects the default mode, a deactivation operation 1210 deactivates the smart control panel as soon as the cursor is moved off of the smart control panel.

A deactivated smart control panel will become more transparent than an activated control panel. Further, a deactivated control panel may change to black-and-white from a color activated smart control panel. Additionally, there may be a time delay incorporated into the deactivation so that the smart control panel does not deactivate immediately when the cursor is moved off of the smart control panel. In a reactivation operation 1215, when the user wishes to use the smart control panel again, he/she re-positions the cursor over the smart control panel to reactivate it. The reactivated smart control panel will become more opaque than the deactivated smart control panel. In some implementations, the reactivated smart control panel becomes colored.

If the user selects the temporal mode, similar to the default mode, a deactivation operation 1220 deactivates the smart control panel when the cursor is moved off of the smart control panel. However, in temporal mode there is a time-delay incorporated into the de-activation and at the expiration of the time-delay, the smart control panel disappears entirely from the display. In a reactivation operation 1225, the user enters a keystroke or menu selection assigned to re-activate the smart control panel. The smart control panel will then reappear at the present location of the cursor on the display. Alternatively, the smart control panel will appear at the same location from which it disappeared.

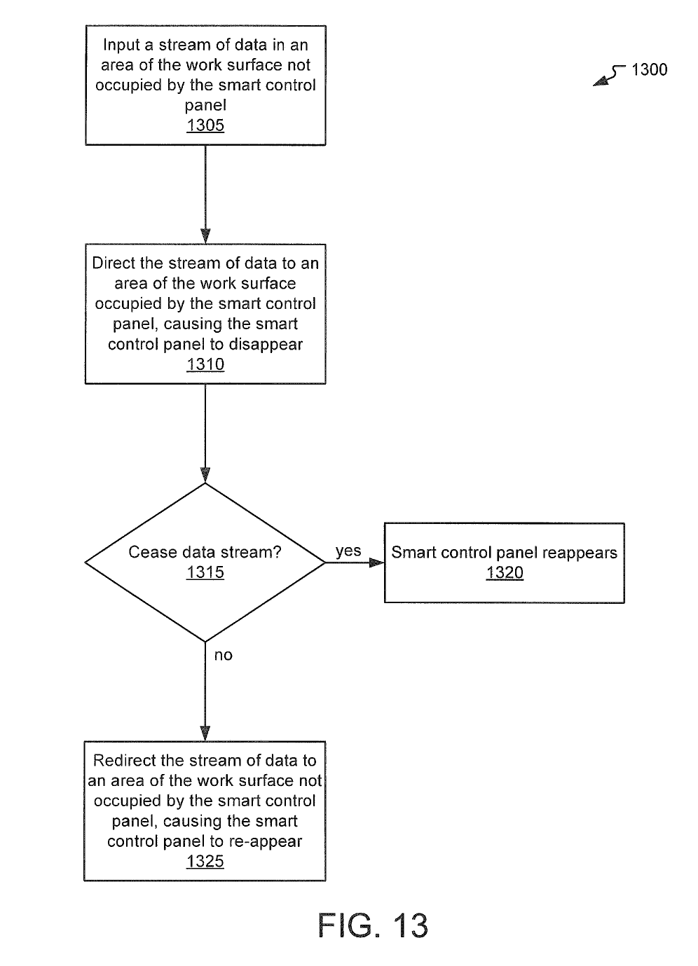

FIG. 13 illustrates example operations 1300 for inputting data on a work surface shown underneath a smart control panel. In an inputting operation 1305, a user inputs a stream of data in an area of the work surface not occupied by the smart control panel. In one implementation, the stream of data is input at the location of a cursor on the work surface. The drawing application tracks the proximity of the cursor to the smart control panel to ensure that the stream of data is not input in an area occupied by the smart control panel. The stream of data may be a rendering on a drawing, text in a word processor, numbers in a spreadsheet, or any other series of data inputs.

In a data entry operation 1310, as the user directs the stream of data over an area of the work surface that is occupied by the smart control panel, the smart control panel disappears. This allows the user unimpeded access to the work surface without the smart control panel interfering with the stream of data. Further, in some implementations, the smart control panel disappears when the stream of data approaches a pre-set distance from the smart control panel.

In a cease data stream decision 1315, the user may decide whether or not to cease the data stream to make the smart control panel reappear. In a first reappearing operation 1320, if the user ceases the data stream while the data is being rendered in the area of the work surface occupied by the smart control panel, the control panel reappears. In a second reappearing operation 1325, if the user merely redirects the data stream to an area of the work surface not occupied by the smart control panel, the smart control panel also reappears.

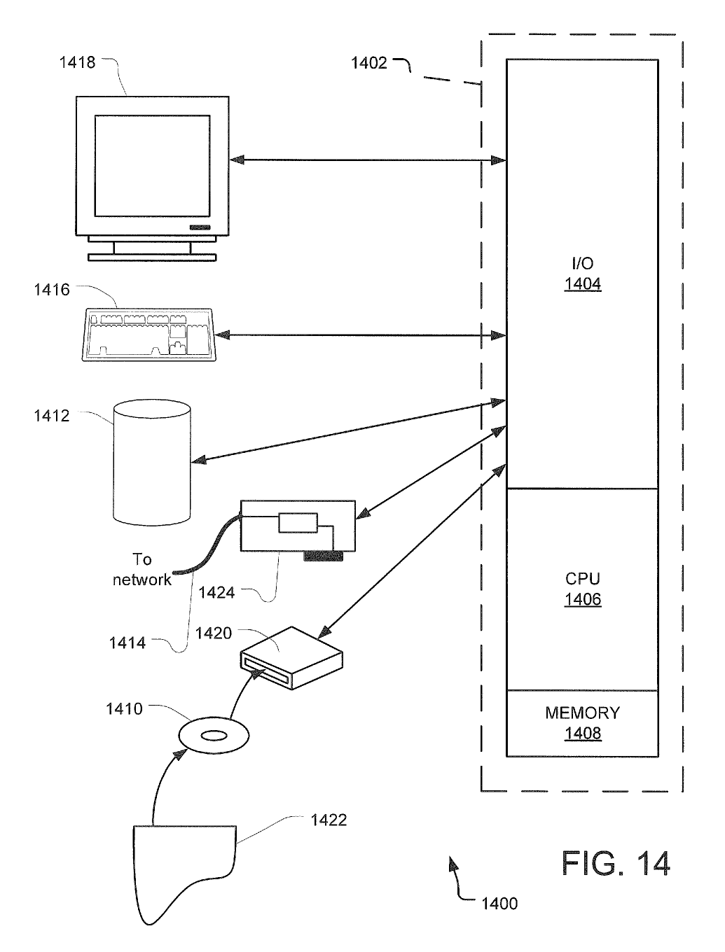

FIG. 14 illustrates an example computing system that can be used to implement the described technology. A general purpose computer system 1400 is capable of executing a computer program product to execute a computer process. Data and program files may be input to the computer system 1400, which reads the files and executes the programs therein. Some of the elements of a general purpose computer system 1400 are shown in FIG. 14 wherein a processor 1402 is shown having an input/output (I/O) section 1404, a Central Processing Unit (CPU) 1406, and a memory section 1408. There may be one or more processors 1402, such that the processor 1402 of the computer system 1400 comprises a single central-processing unit 1406, or a plurality of processing units, commonly referred to as a parallel processing environment. The computer system 1400 may be a conventional computer, a distributed computer, or any other type of computer. The described technology is optionally implemented in software devices loaded in memory 1408, stored on a configured DVD/CD-ROM 1410 or storage unit 1412, and/or communicated via a wired or wireless network link 1414 on a carrier signal, thereby transforming the computer system 1400 in FIG. 14 to a special purpose machine for implementing the described operations.

The I/O section 1404 is connected to one or more user-interface devices (e.g., a keyboard 1416 and a display unit 1418), a disk storage unit 1412, and a disk drive unit 1420. Generally, in contemporary systems, the disk drive unit 1420 is a DVD/CD-ROM drive unit capable of reading the DVD/CD-ROM medium 1410, which typically contains programs and data 1422. Computer program products containing mechanisms to effectuate the systems and methods in accordance with the described technology may reside in the memory section 1404, on a disk storage unit 1412, or on the DVD/CD-ROM medium 1410 of such a system 1400. Alternatively, a disk drive unit 1420 may be replaced or supplemented by a floppy drive unit, a tape drive unit, or other storage medium drive unit. The network adapter 1424 is capable of connecting the computer system to a network via the network link 1414, through which the computer system can receive instructions and data embodied in a carrier wave. Examples of such systems include Intel and PowerPC systems offered by Apple Computer, Inc., personal computers offered by Dell Corporation and by other manufacturers of Intel-compatible personal computers, AMD-based computing systems and other systems running a Windows-based, UNIX-based, or other operating system. It should be understood that computing systems may also embody devices such as Personal Digital Assistants (PDAs), mobile phones, gaming consoles, set top boxes, etc.

When used in a LAN-networking environment, the computer system 1400 is connected (by wired connection or wirelessly) to a local network through the network interface or adapter 1424, which is one type of communications device. When used in a WAN-networking environment, the computer system 1400 typically includes a modem, a network adapter, or any other type of communications device for establishing communications over the wide area network. In a networked environment, program modules depicted relative to the computer system 1400 or portions thereof, may be stored in a remote memory storage device. It is appreciated that the network connections shown are exemplary and other means of and communications devices for establishing a communications link between the computers may be used.

In an example implementation, smart control panel modules, circular palette modules, and/or a drawing module, may be incorporated as part of the operating system, application programs, or other program modules. A database containing smart control panel modules and/or associated GUIs may be stored as program data in memory 1408 or other storage systems, such as disk storage unit 1412 or DVD/CD-ROM medium 1410.

The present specification provides a complete description of the methodologies, systems and/or structures and uses thereof in example implementations of the presently-described technology. Although various implementations of this technology have been described above with a certain degree of particularity, or with reference to one or more individual implementations, those skilled in the art could make numerous alterations to the disclosed implementations without departing from the spirit or scope of the technology hereof. Since many implementations can be made without departing from the spirit and scope of the presently described technology, the appropriate scope resides in the claims hereinafter appended. Other implementations are therefore contemplated. Furthermore, it should be understood that any operations may be performed in any order, unless explicitly claimed otherwise or a specific order is inherently necessitated by the claim language. It is intended that all matter contained in the above description and shown in the accompanying drawings shall be interpreted as illustrative only of particular implementations and are not limiting to the embodiments shown. Changes in detail or structure may be made without departing from the basic elements of the present technology as defined in the following claims.

What is claimed:

1. A method comprising:
detecting user input on a first layer underneath a graphical user interface (GUI) within a proximity of the GUI using a processing unit, wherein an area of the first layer is obscured by the GUI on a second layer; and
revealing the obscured area of the first layer, responsive to detecting the data input on the first layer underneath the GUI.

2. The method of claim 1, wherein the user input is a stream of data, further comprising:
detecting an end of the stream of data input on the first layer within the proximity of the GUI, and
revealing the GUI on the second layer, responsive to detecting the end of the stream of data.

3. The method of claim 1, wherein the user input is a stream of data, further comprising:
detecting the stream of data input on the first layer outside the proximity of the GUI, and
revealing the GUI on the second layer, responsive to detecting the stream of data input outside the proximity of the GUI.

4. The method of claim 1, wherein the revealing operation comprises:
repositioning the GUI on a computer display.

5. The method of claim 1, wherein the revealing operation comprises:
rendering the GUI more transparent on a computer display.

6. The method of claim 1, wherein the first layer includes a virtual canvas.

7. The method of claim 1, wherein the user input is a rendering associated with movement of a cursor on a computer display.

8. The method of claim 1, wherein the user input is text entered at a cursor on a computer display.

9. The method of claim 1, wherein the GUI is a smart control panel.

10. A system comprising:
a detection module configured to detect user input on a first layer underneath a graphical user interface (GUI) within a proximity of the GUI, wherein an area of the first layer is obscured by the GUI on a second layer; and
an input/output module configured to reveal the obscured area of the first layer, responsive to detecting the data input on the first layer underneath the GUI.

11. The system of claim 10, wherein the user input is a stream of data, wherein the detection module is further configured to detect an end of the stream of data input on the first layer within the proximity of the GUI, and wherein the input/output module is further configured to reveal the GUI on the second layer, responsive to detecting the end of the stream of data.

12. The system of claim 10, wherein the user input is a stream of data, wherein the detection module is further configured to detect the stream of data input on the first layer outside the proximity of the GUI, and wherein the input/output module is further configured to reveal the GUI on the second layer, responsive to detecting the stream of data input outside the proximity of the GUI.

13. The system of claim 10, wherein the input/output module is further configured to reposition the GUI on a computer display to reveal the obscured area of the first layer.

14. The system of claim 10, wherein the input/output module is further configured to render the GUI more transparent on a computer display to reveal the obscured area of the first layer.

15. The system of claim 10, wherein the first layer includes a virtual canvas.

16. The system of claim 10, wherein the user input is a rendering associated with movement of a cursor on a computer display.

17. The system of claim 10, wherein the user input is text entered at a cursor on a computer display.

18. The system of claim 10, wherein the GUI is a smart control panel.

19. One or more computer readable storage media storing computer-executable instructions for performing a computer process, the computer process comprising:
detecting user input on a first layer underneath a graphical user interface (GUI) within a proximity of the GUI using a processing unit, wherein an area of the first layer is obscured by the GUI on a second layer; and
revealing the obscured area of the first layer, responsive to detecting the data input on the first layer underneath the GUI.

20. The one or more computer readable storage media of claim 19, wherein the user input is a stream of data, the computer process further comprising:
detecting an end of the stream of data input on the first layer within the proximity of the GUI, and
revealing the GUI on the second layer, responsive to detecting the end of the stream of data.

21. The one or more computer readable storage media of claim 19, wherein the user input is a stream of data, the computer process further comprising:
detecting the stream of data input on the first layer outside the proximity of the GUI, and
revealing the GUI on the second layer, responsive to detecting the stream of data input outside the proximity of the GUI.

22. The one or more computer readable storage media of claim 19, wherein the revealing operation comprises:
repositioning the GUI on a computer display.

23. The one or more computer readable storage media of claim 19, wherein the revealing operation comprises:
rendering the GUI more transparent on a computer display.

24. The one or more computer readable storage media of claim 19, wherein the first layer includes a virtual canvas.

25. The one or more computer readable storage media of claim 19, wherein the user input is a rendering associated with movement of a cursor on a computer display.

26. The one or more computer readable storage media of claim 19, wherein the user input is text entered at a cursor on a computer display.

27. The one or more computer readable storage media of claim 19, wherein the GUI is a smart control panel.
